(19) United States
(12) Patent Application Publication
(10) Pub. No.: US 2023/0115276 A1
(43) Pub. Date: Apr. 13, 2023

(54) AIR PURIFIER

(71) Applicant: Airplove (Xiamen) Electronic Co., Ltd., Xiamen (CN)

(72) Inventors: Jueyuan Chen, Xiamen (CN); Huiping Cai, Xiamen (CN); Longzhe Chen, Xiamen (CN)

(21) Appl. No.: 17/653,929

(22) Filed: Mar. 8, 2022

(30) Foreign Application Priority Data
Sep. 29, 2021 (CN) 202111153514.7

(51) Int. Cl. B01D 46/10; B01D 46/42; B01D 46/76

(52) U.S. Cl. CPC B01D 46/106; B01D 46/76; B01D 46/429; B01D 46/4227; B01D 2221/02; B01D 2221/08; B01D 2273/30

(57) ABSTRACT

The present invention discloses an air purifier, including: an air intake structure and an air discharge structure. The air intake structure is connected and fixed to the air discharge structure via a quick-release structure, the air intake structure is provided with a filter screen, and placement/removal of the filter screen is enabled through engagement/disengagement of the quick-release structure. The air purifier of the present invention has a simple structure and a rational design. The air purifier is divided into two parts, namely an air discharge structure and an air intake structure which are arranged one above the other, and quick dismounting and mounting of the upper part and the lower part are enabled by means of the quick-release structure, thereby realizing quick and easy replacement of the filter screen, and effectively improving the replacement efficiency. In addition, the air purifier has a simple and attractive appearance.

### TECHNICAL FIELD

The present invention relates to the technical field of air purification, and in particular to an air purifier.

### BACKGROUND

Air purifiers, also known as air cleaners, air fresheners and purifiers, refer to household appliances that can absorb, decompose or transform various air pollutants (generally including PM2.5, dust, pollen, decoration pollutants such as odor and formaldehyde, bacteria and allergens, etc.) and effectively improve air cleanliness. They are mainly divided into household, commercial, industrial and building products.

With the development of society and the continuous improvement of living standards, people pay more and more attention to the air quality in the home environment. However, the replacement of a filter screen of the existing air purifier is extremely inconvenient after long-term use, and even it is necessary to disassemble the whole purifier. The disassembly process is cumbersome and laborious, which will waste a lot of time for people, resulting in an unsatisfactory use effect and poor experience.

In view of this, the inventor of the present application has invented an air purifier.

### SUMMARY

An objective of the present invention is to provide an air purifier with a quickly and easily replaceable filter screen.

To achieve the above objective, the present invention adopts the following technical scheme: an air purifier including an air intake structure and an air discharge structure, where the air intake structure is connected and fixed to the air discharge structure via a quick-release structure, the air intake structure is provided with a filter screen, and placement/removal of the filter screen is enabled through engagement/disengagement of the quick-release structure.

Further, the air intake structure is located below the air discharge structure; the air intake structure includes a filter cavity, and a clearance hole in communication with the filter cavity is provided at a top end of the air intake structure; and the filter screen is placed into the filter cavity through the clearance hole.

Further, the quick-release structure includes a slider which is provided at the bottom of the air discharge structure and is movable horizontally relative to the air discharge structure, snap hooks are provided at a bottom end of the slider, and snap-fit portions capable of being matched and snap-fitted with the snap hooks are provided at the top end of the air intake structure.

Further, strip-shaped snap grooves, which are provided in a sliding direction of the slider, are provided at the top end of the air intake structure, each of the snap-fit portions is located at one end of a respective snap groove, and an end face of the snap-fit portion near the other end of the snap groove is an inclined guide face, which inclines downwardly toward the other end of the snap groove.

Further, the snap hook is L-shaped, and includes a vertical portion and a horizontal portion with one end of the vertical portion connected to one end of the horizontal portion, and an end face of the horizontal portion at one end remote from the vertical portion is an inclined driving face, which inclines downwardly toward the vertical portion.

Further, the air discharge structure is provided with guide rails matched with the slider, and the quick-release structure further includes return springs arranged in the sliding direction of the slider, each of the return spring having one end connected to the slider and the other end connected to a respective guide rail.

Further, the slider is π-shaped as a whole, and includes a connection portion and two sliding portions connected to two ends of the connection portion, respectively; a pressing portion is provided in the middle of the connection portion, and the pressing portion and the sliding portions are respectively located on two sides of the connection portion; and an outer wall of the air discharge structure is provided with a pressing hole, and the pressing portion is located in the pressing hole.

Further, the air discharge structure includes an upper housing, and the air intake structure includes a lower housing, where a side wall of the upper housing extends downwardly to form an extended side wall, an inner wall of the extended side wall is provided with an inner step, and an outer wall of the lower housing is provided with an outer step which is adapted and mounted to the inner step.

Further, a connection seat is provided in the air intake structure, and the connection seat is provided in the filter screen; a male coupler end is provided at a top end of the connection seat; and a female coupler end, which is adapted and connected to the male coupler end, is provided at a bottom end of the air discharge structure.

Further, the air intake structure is internally provided with a photocatalyst assembly sleeved around the connection seat, a probe is provided at a top end of the photocatalyst assembly, and a probe printed circuit board (PCB) contact matched with the probe is provided at the bottom end of the air discharge structure.

After adopting the technical scheme, the present invention has the following advantages:

The air purifier of the present invention has a simple structure and a rational design. The air purifier is divided into two parts, namely an air discharge structure and an air intake structure which are arranged one above the other, and quick dismounting and mounting of the upper part and the lower part are enabled by means of the quick-release structure, thereby realizing quick and easy replacement of the filter screen, and effectively improving the replacement efficiency. In addition, the air purifier has a simple and attractive appearance.

### BRIEF DESCRIPTION OF DRAWINGS

FIG. 1 is a schematic perspective view of an air purifier according to an embodiment of the present invention;

FIG. 2 is an exploded schematic view of the air purifier according to the embodiment of the present invention;

FIG. 3 is a schematic view, from the bottom, of an air discharge structure according to the embodiment of the present invention;

FIG. 4 is a schematic view of an air intake structure according to the embodiment of the present invention;

FIG. 5 is an exploded schematic view of the air intake structure according to the embodiment of the present invention;

FIG. 6 is a schematic view of the air intake structure according to the embodiment of the present invention with a photocatalyst assembly hidden;

FIG. 7 is an assembled schematic view of a quick-release structure according to the embodiment of the present invention;

FIG. 8 is an exploded schematic view of the quick-release structure according to the embodiment of the present invention; and

FIG. 9 is a schematic view of a guide rail according to the embodiment of the present invention.

### Description of Reference Signs

10 - Air discharge structure,
11 - Upper housing, 111 - Extended side wall, 112 - Inner step,
12 - Air outlet,
13 - Boss, 131 - Air vent,
14 - Female coupler end,
15 - Probe PCB contact,
20 - Air intake structure,
21 - Lower housing, 211 - Air inlet, 212 - Clearance hole, 213 - Outer step,
22 - Filter screen,
23 - Connection seat, 231 - Male coupler end, 232 - Positioning portion,
24 - Photocatalyst assembly, 241 - Probe,
30 - Quick-release structure,
31 - Slider, 311 - Connection portion, 312 - Sliding portion, 313 - Pressing portion, 314 - Limiting plate,
32 - Snap hook, 321 - Vertical portion, 322 - Horizontal portion, 323 -Inclined driving face,
33 - Strip-shaped snap groove, 331 - Snap-fit portion, 332 - Inclined guide face,
34 - Guide rail, 341 - Baffle plate, and
35 - Return spring.

### DETAILED DESCRIPTION

In order to make the objectives, technical schemes and advantages of the present invention more apparent, the present invention is further described in detail in conjunction with the accompanying drawings and embodiments. It should be understood that the specific embodiments described here are intended only to explain the present invention and are not intended to limit the present invention.

In the present invention, it should be noted that the terms “up”, “down”, “left”, “right”, “vertical”, “horizontal”, “inside” and “outside” are all based on the orientation or positional relationship shown in the drawings, only for the convenience of describing the present invention and simplifying the description, and do not indicate or imply that the device or element of the present invention must have a specific orientation, so it cannot be understood as limiting the present invention.

### Embodiment

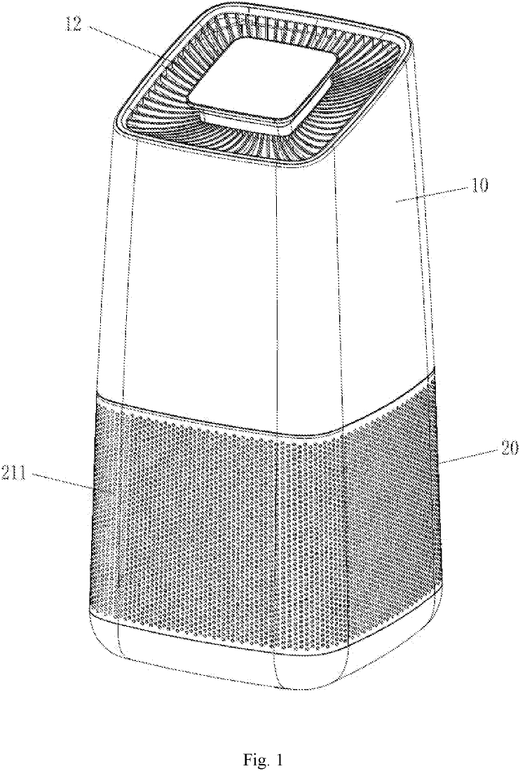

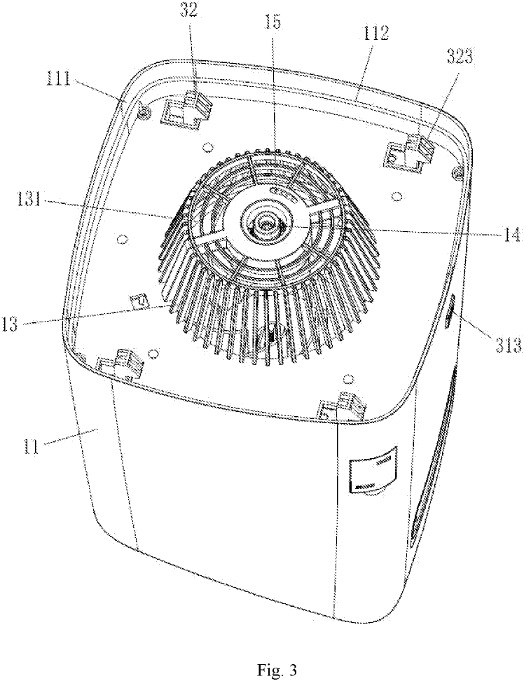

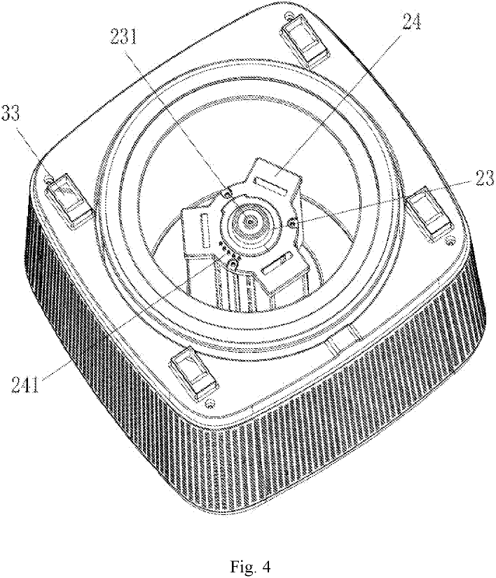

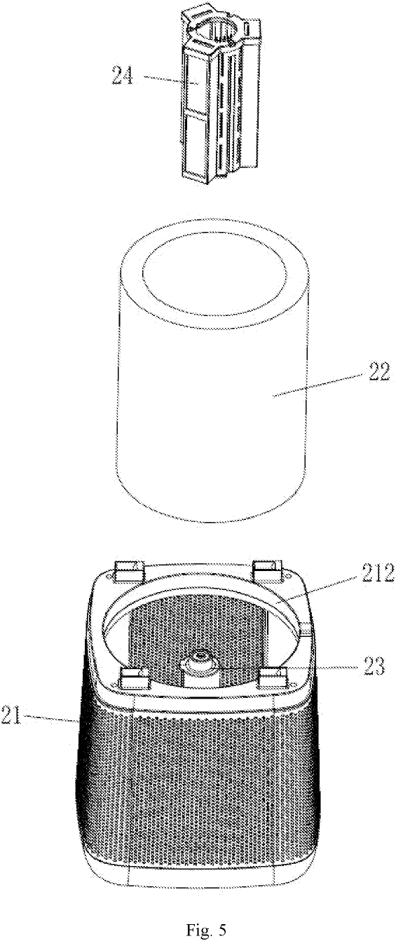

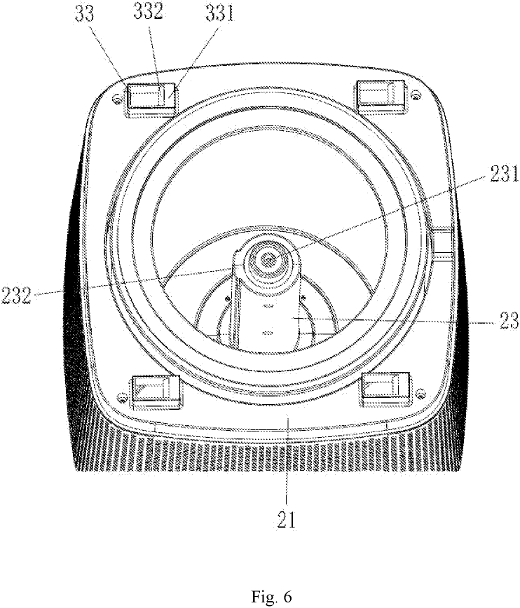

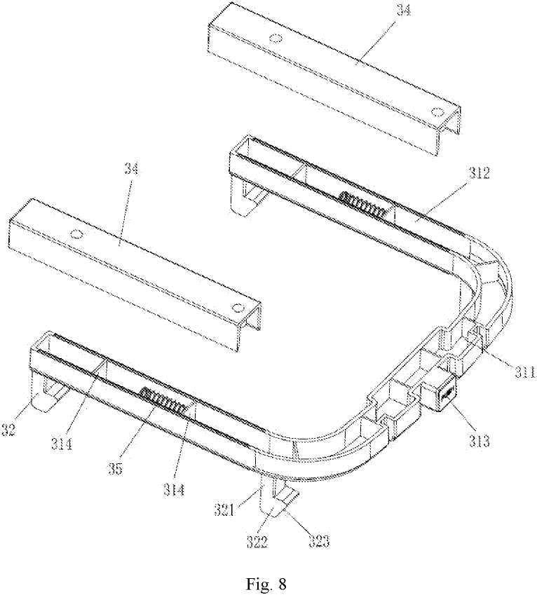

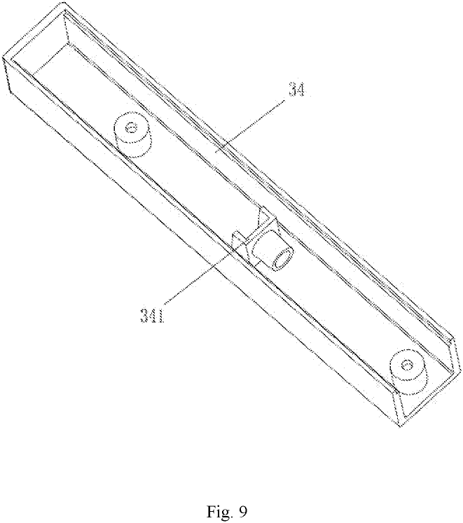

Referring to FIGS. 1 to 9, the present invention discloses an air purifier including an air intake structure 20 and an air discharge structure 10. The air intake structure 20 is connected and fixed to the air discharge structure 10 via a quick-release structure 30, the air intake structure 20 is provided with a filter screen 22, and placement/removal of the filter screen 22 is enabled through engagement/disengagement of the quick-release structure 30 for the filter screen 22. More specifically, the air intake structure 20 is located below the air discharge structure 10. The air intake structure 20 includes a filter cavity, and a clearance hole 212 in communication with the filter cavity is provided at the top end of the air intake structure 20. The filter screen 22 is placed into the filter cavity through the clearance hole 212. The quick-release structure 30 can enable the quick dismounting and mounting of the air discharge structure 10 and the air intake structure 20, thereby providing a basis for quick replacement of the filter screen 22.

Referring to FIGS. 1 to 3, the air discharge structure 10 includes an upper housing 11 provided with an air outlet 12 at the top and a boss 13 at the middle of the bottom end. The boss 13 is provided with an air vent 131. The upper housing 11 is internally provided with an air discharge channel and a fan. The fan rotates to form an airflow. Outside air enters the lower air intake structure 20, and the air in the air intake structure 20 enters the air discharge channel through the air vent 131 and is finally discharged through the air outlet 12 at the top end of the upper housing 11.

Referring to FIGS. 1 to 7, the air intake structure 20 includes a lower housing 21 and the filter screen 22. The lower housing 21 is hollow and forms the filter cavity, and the clearance hole 212 is located at a top end of the lower housing 21. A side wall of the lower housing 21 is provided with air inlets 211, the air inlets 211 are densely arranged, and the entire circumferential side wall of the lower housing 21 is provided with the air inlets 211, so that the air intake amount can be effectively ensured. The air outside the filter screen 22 enters the lower housing 21 through the air inlets 211, and enters the air discharge structure 10 through the air vent 131 after being filtered by the filter screen 22. Specifically, the filter screen 22 is in the shape of an annular cylinder with an outer diameter adapted to the diameter of the clearance hole 212. The mounting is enabled only by directly inserting the filter screen 22 through the clearance hole 212, which is easy and quick. After the air discharge structure 10 and the air intake structure 20 are assembled, the top end of the filter screen 22 protrudes from the top end of the lower housing 21 and abuts against an outer bottom wall of the upper housing 11, so that the boss 13 at the bottom end of the upper housing 11 directly extends into the filter screen 22, thereby ensuring that the air entering the lower housing 21 through the air inlets 211 must be filtered by the filter screen 22 before entering the air discharge structure 10 through the air vent 131, and effectively ensuring the purification effect.

A connection seat 23 is provided in lower housing 21, that is, in the filter cavity. More specifically, the connection seat 23 is located in the filter screen 22 and in the middle of the lower housing 21. A male coupler end 231 is provided at a top end of the connection seat, and a female coupler end 14, which is adapted and connected to the male coupler end 231, is provided at the bottom end of the upper housing 11. The female coupler end 14 is arranged in the middle of the boss 13. After the air purifier is assembled, the energizing of the air discharge structure 10 and the air intake structure 20 is enabled by means of the female coupler end 14 and the male coupler end 231, which is simple and quick.

The lower housing 21 is further internally provided with a photocatalyst assembly 24, specifically a UV lamp photocatalyst assembly 24, which includes a photocatalyst plate and a UV lamp. The photocatalyst assembly 24 is centrally provided with a through hole adapted to the connection seat 23, and is sleeved around the connection seat 23 by means of the through hole, so as to mount and fix the photocatalyst assembly. The photocatalyst assembly is of an integrated design, so that the photocatalyst assembly can be easily dismounted. In addition, an outer wall of the connection seat 23 is provided with a positioning portion 232, so that the accurate and quick mounting of the photocatalyst assembly 24 can be ensured. A probe 241 is provided at a top end of the photocatalyst assembly 24, and a probe PCB contact 15 matched with the probe 241 is provided at the bottom end of the upper housing 11. The arrangement of the probe 241 and the probe PCB contact 15 makes the energizing of the photocatalyst assembly simple and quick. The UV lamp photocatalyst assembly 24 may decompose and oxidize organic substances and some inorganic substances harmful to the human body or environment in the air, so as to purify the air. The air filtered by the filter screen 22 is purified by the UV lamp photocatalyst assembly 24, and then enters the air discharge structure 10 and is discharged through the air outlets 12.

A side wall of the upper housing 11 extends downwardly to protrude from its bottom wall, forming an extended side wall 111. An inner wall of the extended side wall 111 is provided with an inner step 112. The inner step 112 is specifically composed of the bottom wall and the extended side wall 111 of the upper housing 11. The outer wall of the lower housing 21 is provided with an outer step 213 which is adapted and mounted to the inner step 112. When the air discharge structure 10 and the air intake structure 20 are assembled by means of the quick-release structure 30, the upper housing 11 and the lower housing 21 are fitted with each other by means of the inner step 112 and the outer step 213, so that the overall attractive appearance of the air purifier can be ensured. At the same time, the extended side wall 111 also provides a certain mounting space for the quick-release structure 30.

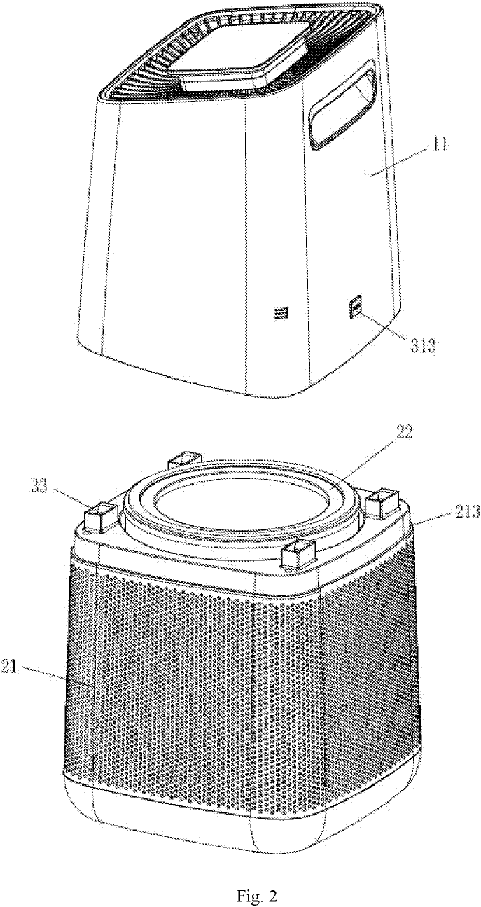

Referring to FIGS. 2 to 9, the quick-release structure 30 includes a slider 31 which is provided at the bottom of the air discharge structure 10 and is movable horizontally relative to the air discharge structure 10, snap hooks 32 are provided at a bottom end of the slider 31, and snap-fit portions 331 capable of being matched and snap-fitted with the snap hooks 32 are provided at the top end of the air intake structure 20. Specifically, the slider 31 can horizontally reciprocate between a first position and a second position relative to the air discharge structure 10. When the slider 31 is located in the first position, the slider 31 is correspondingly snap-fitted with and fixed to the snap-fit portions 331, and at this time, the air discharge structure 10 and the air intake structure 20 are assembled and fixed, so that the whole air purifier can be lifted by means of a handle arranged outside the air discharge structure 10. When the slider 31 is located in the second position, the snap hooks 32 are detached from the snap-fit portions 331. At this time, the air discharge structure 10 and the air intake structure 20 are in a detachable state, and the air discharge structure 10 can be lifted directly to realize separation of the air discharge structure 10 from the air intake structure 20, so as to facilitate the replacement of the filter screen 22 in the air intake structure 20 or other operations.

Specifically, the slider 31 is located inside the air discharge structure 10, and the snap hook 32 passes through the bottom wall of the upper housing 11 and extends to the outside of the upper housing 11, so that the appearance of the air discharge structure 10 is simpler and more attractive. The slider 31 is π-shaped as a whole and is horizontally arranged, and specifically includes a connection portion 311 and two sliding portions 312 connected to two ends of the connection portion 311, which are correspondingly located on the peripheral side of the clearance hole 212. The two sliding portions 312 are arranged in parallel, and connections between the sliding portions 312 and the connection portion 311 are circular arc transitions. The slider 31 is further provided with a pressing portion 313 for allowing the slider 31 to be pressed and driven to move, and the pressing portion 313 is located in the middle of the connection portion 311. The pressing portion 313 and the sliding portions 312 are respectively located on two sides of the connection portion 311. The side wall of the upper housing 11 is provided with a pressing hole in which the pressing portion 313 is located. When the slider 31 is in the first position, an end face of the pressing portion 313 is flush with the outer wall of the upper housing 11. One can move the slider 31 from the first position to the second position by pressing the pressing portion 313 from outside through the pressing hole.

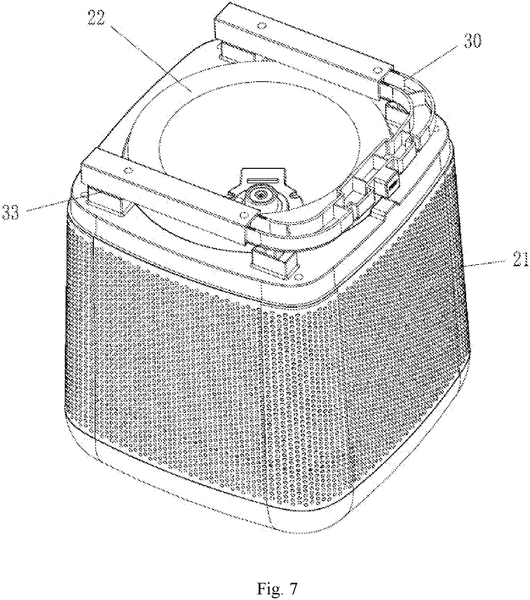

Referring to FIGS. 7 to 9, the air discharge structure 10 is provided with guide rails 34 matched with the slider 31. When the slider 31 moves, the sliding portions 312 slide along the guide rails 34. Correspondingly, the two sliding portions 312 are each provided with one guide rail 34. The quick-release structure 30 further includes return springs 35 arranged in the sliding direction of the slider 31. Each of the return springs 35 has one end connected to the slider 31 and the other end connected to a respective guide rail 34. Specifically, the guide rail 34 includes a sliding groove with a downward opening. The slider 31 is hollow and has an upper end that is not closed. The sliding portions 312 are matched with and embedded in the sliding grooves of the guide rails 34. A baffle plate 341 is arranged in the sliding groove, and two limiting plates 314 are arranged in the sliding portion 312, and the baffle plate 341 is located between the two limiting plates 314. One end of the return spring 35 abuts against one of the limiting plates 314, and the other end thereof abuts against the baffle plate 341. When the pressing portion 313 is pressed to move the slider 31 to the second position, the return springs 35 are in a compressed state. When the pressure exerted on the pressing portion 313 is removed, and the slider 31 returns to the first position under the action of the return springs 35.

The snap hooks 32 are located at the bottom end of the sliding portion 312. Two ends of each sliding portion 312 are each provided with one snap hook 32, and there are totally four snap hooks 32, so that the air purifier can be assembled and fixed more stably. Specifically, the snap hook 32 is L-shaped, including a vertical portion 321 and a horizontal portion 322 with one end of the vertical portion connected to one end of the horizontal portion. The snap hooks 32 are arranged in the same orientation. When the snap hook 32 is snap-fitted with a respective snap-fit portion 331, the horizontal portion 322 of the snap hook is located below the snap-fit portion 331, an end face of the horizontal portion 322 at one end remote from the vertical portion 321 is an inclined driving face 323, and the inclined driving face 323 inclines downwardly toward the vertical portion 321.

Strip-shaped snap grooves 33, which are provided in the sliding direction of the slider 31, are provided at the top end of the air intake structure 20. There are also four corresponding strip-shaped snap grooves 33. Each of the snap-fit portions 331 is located at one end of a respective snap groove, and an end face of the snap-fit portion 331 near the other end of the snap groove is an inclined guide face 332, and the inclined guide face 332 inclines downwardly toward the other end of the snap groove. The four strip-shaped snap grooves 33 are distributed at four corners of the upper end of the lower housing 21.

When the air discharge structure 10 and the air intake structure 20 are assembled by means of the quick-release structure 30, the snap hooks 32 are aligned with the positions of the snap grooves, and an air draft and guide mechanism is pressed downwardly to make same move downwardly (the gravity of the air draft and guide mechanism will also make same move downwardly). The arrangement of the inclined guide face 332 and the inclined driving face 323 makes it easier for the snap hook 32 to enter the snap groove. As the snap hook 32 slowly enters the snap groove, due to the arrangement of the inclined driving face 323, the slider 31 will slowly move to the second position (at this time, the return springs 35 are slowly compressed), until the horizontal portion 322 completely moves downwardly below the snap-fit portion 331. The slider 31 will move to the first position under the action of the return springs 35, such that the snap hook 32 is snap-fitted with the snap-fit portion 331, thereby realizing the mounting and fixation of the air discharge structure 10 and the air intake structure 20. In this way, the process is easy and quick.

When it is necessary to disassemble the air discharge structure 10 and the air intake structure 20 by means of the quick-release structure 30, the pressing portion 313 is pressed from the outside of the air purifier through the pressing hole, such that the slider 31 is moved from the first position to the second position (the return springs 35 are compressed). At this time, the snap hooks 32 are in the detached state from the snap-fit portions 331, and the air discharge structure 10 is directly lifted up. At the same time, the snap hooks 32 are moved upwardly until they are detached from the snap grooves to separate the air discharge structure 10 from the air intake structure 20. At this time, the slider 31 also returns to the first position under the action of the return springs 35. After the air discharge structure 10 is detached from the air intake structure 20, the filter screen 22 can be directly replaced or other implementable operations can be carried out, which is easy and quick.

Only a preferred embodiment of the present invention is described above, and the scope of protection of the present invention is not limited thereto. Any changes or substitutions that can be readily conceived by those skilled in the art within the technical scope disclosed by the present invention shall fall within the scope of protection of the present invention. Therefore, the scope of protection of the present invention should be subject to the scope of protection of the claims.

1. An air purifier, comprising: an air intake structure and an air discharge structure, wherein the air intake structure is connected and fixed to the air discharge structure via a quick-release structure, the air intake structure is provided with a filter screen, and placement/removal of the filter screen is enabled through engagement/disengagement of the quick-release structure.

2. The air purifier of claim 1, wherein the air intake structure is located below the air discharge structure; the air intake structure comprises a filter cavity, and a clearance hole in communication with the filter cavity is provided at a top end of the air intake structure; and the filter screen is placed into the filter cavity through the clearance hole.

3. The air purifier of claim 2, wherein the quick-release structure comprises a slider which is provided at the bottom of the air discharge structure and is movable horizontally relative to the air discharge structure, snap hooks are provided at a bottom end of the slider, and snap-fit portions capable of being matched and snap-fitted with the snap hooks are provided at the top end of the air intake structure.

4. The air purifier of claim 3, wherein strip-shaped snap grooves, which are provided in a sliding direction of the slider, are provided at the top end of the air intake structure, each of the snap-fit portions is located at one end of a respective snap groove, and an end face of the snap-fit portion near the other end of the snap groove is an inclined guide face, which inclines downwardly toward the other end of the snap groove.

5. The air purifier of claim 3, wherein the snap hook is L-shaped, and comprises a vertical portion and a horizontal portion with one end of the vertical portion connected to one end of the horizontal portion, and an end face of the horizontal portion at one end remote from the vertical portion is an inclined driving face, which inclines downwardly toward the vertical portion.

6. The air purifier of claim 3, wherein the air discharge structure is provided with guide rails matched with the slider, and the quick-release structure further comprises return springs arranged in the sliding direction of the slider, each of the return springs having one end connected to the slider and the other end connected to a respective guide rail.

7. The air purifier of claim 3, wherein the slider is π-shaped as a whole, and comprises a connection portion and two sliding portions connected to two ends of the connection portion, respectively; a pressing portion is provided in the middle of the connection portion, and the pressing portion and the sliding portions are respectively located on two sides of the connection portion; and an outer wall of the air discharge structure is provided with a pressing hole, and the pressing portion is located in the pressing hole.

8. The air purifier of claim 2, wherein the air discharge structure comprises an upper housing, and the air intake structure comprises a lower housing, wherein a side wall of the upper housing extends downwardly to form an extended side wall, an inner wall of the extended side wall is provided with an inner step, and an outer wall of the lower housing is provided with an outer step which is adapted and mounted to the inner step.

9. The air purifier of claim 2, wherein a connection seat is provided in the air intake structure, and the connection seat is provided in the filter screen; a male coupler end is provided at a top end of the connection seat; and a female coupler end, which is adapted and connected to the male coupler end, is provided at a bottom end of the air discharge structure.

10. The air purifier of claim 9, wherein the air intake structure is internally provided with a photocatalyst assembly sleeved around the connection seat, a probe is provided at a top end of the photocatalyst assembly, and a probe printed circuit board (PCB) contact matched with the probe is provided at the bottom end of the air discharge structure.

11. The air purifier of claim 4, wherein the snap hook is L-shaped, and comprises a vertical portion and a horizontal portion with one end of the vertical portion connected to one end of the horizontal portion, and an end face of the horizontal portion at one end remote from the vertical portion is an inclined driving face, which inclines downwardly toward the vertical portion.

12. The air purifier of claim 4, wherein the air discharge structure is provided with guide rails matched with the slider, and the quick-release structure further comprises return springs arranged in the sliding direction of the slider, each of the return springs having one end connected to the slider and the other end connected to a respective guide rail.

13. The air purifier of claim 4, wherein the slider is π-shaped as a whole, and comprises a connection portion and two sliding portions connected to two ends of the connection portion, respectively; a pressing portion is provided in the middle of the connection portion, and the pressing portion and the sliding portions are respectively located on two sides of the connection portion; and an outer wall of the air discharge structure is provided with a pressing hole, and the pressing portion is located in the pressing hole.
